(19) United States
(12) Patent Application Publication
(10) Pub. No.: US 2010/0027472 A1
(43) Pub. Date: Feb. 4, 2010

(54) INTERNET PHONE COMMUNICATION METHOD AND SYSTEM THEREOF

(76) Inventors: Xiao-Feng MAO, Shanghai City (CN); Li YU, Shanghai City (CN); Shih-Kuang TSAI, Shanghai City (CN)

Correspondence Address: Muncy, Geissler, Olds & Lowe, PLLC, P.O. BOX 1364, FAIRFAX, VA, 22038-1364, US

(21) Appl. No.: 12/511,685

(22) Filed: Jul. 29, 2009

(30) Foreign Application Priority Data
Jul. 29, 2008 (TW) 97128682

(51) Int. Cl. H04L 12/66; H04W 4/00

(52) U.S. Cl. 370/328; 370/352

(57) ABSTRACT

An Internet phone communication method includes selecting a destination media access control address from a phone book, transmitting the destination media access control address to an address server having at least one valid media access control address stored therein, checking whether the destination media access control address matches the valid media access control address, communicating with a receiver having the destination media access control address or the valid media access control address via a wireless network system other than a cellular network system when the destination media access control address matches the valid media access control address. An Internet phone communication system is also disclosed herein.

### RELATED APPLICATIONS

This application claims priority to Taiwan Application Serial Number 97128682, filed Jul. 29, 2008, which is herein incorporated by reference.

### BACKGROUND

1. Field of Invention

The present invention relates to an Internet phone communication method and system. More particularly, the present invention relates to an Internet phone communication method and system where phone communication is made via a wireless network.

2. Description of Related Art

With the development of mobile technologies, mobile phones have become one of the communication devices people frequently use. For most people, the major use of mobile phones is for calling each other at a convenient time or place, so the associated calling and receiving cost usually makes up the largest portion on the phone bill.

IEEE 802.11 is a set of standards for wireless local area network (WLAN) computer communication, developed by the IEEE LAN/MAN Standards Committee (IEEE 802) in the 5 GHz and 2.4 GHz public spectrum bands. Although the terms 802.11 and Wi-Fi are often used interchangeably, the Wi-Fi Alliance uses the term “Wi-Fi” to define a slightly different set of overlapping standards. In some cases, market demand has led the Wi-Fi Alliance to begin certifying products before amendments to the 802.11 standard are completed. With the functions supported by mobile phones enhance over time, more and more mobile phones are equipped with Wi-Fi. Other than the home and office area, more and more Wi-Fi hot spots are set up in places like airports, railway stations, coffee shops and libraries. In these places, people can access high-speed Internet via access points once they are connected to WLAN.

Most mobile phone users use the Wi-Fi feature to browse websites and receive or send e-mail. However, as VoIP (Voice over Internet Protocol) developed, there are still possibilities for mobile phone users to utilize the Wi-Fi functionality.

### SUMMARY

According to one embodiment of the present invention, an Internet phone communication method includes selecting a destination media access control address from a phone book, transmitting the destination media access control address to an address server having at least one valid media access control address stored therein, checking whether the destination media access control address matches the valid media access control address, communicating with a receiver having the destination media access control address or the valid media access control address via a wireless network system other than a cellular network system when the destination media access control address matches the valid media access control address.

According to another embodiment of the present invention, an Internet phone communication system includes an address server for storing at least one valid media access control address, a selecting module for selecting a destination media access control address, a transmitting module for transmitting the destination media access control address to the address server, a checking module for checking whether the destination media access control address matches the valid media access control address, and a wireless network transmitting module for communicating with a receiver having the destination media access control address or the valid media access control address via a wireless network system other than a cellular network system, when the destination media access control address matches the valid media access control address.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a flow chart showing an Internet phone communication method according to one embodiment of this invention; and

FIG. 2 is a block diagram showing an Internet phone communication system according to another embodiment of this invention.

### DESCRIPTION OF THE PREFERRED EMBODIMENTS

Reference will now be made in detail to the embodiment of this invention, examples of which are illustrated in the accompanying drawings. Wherever possible, the same reference numbers are used in the drawings and the description to refer to the same or like parts.

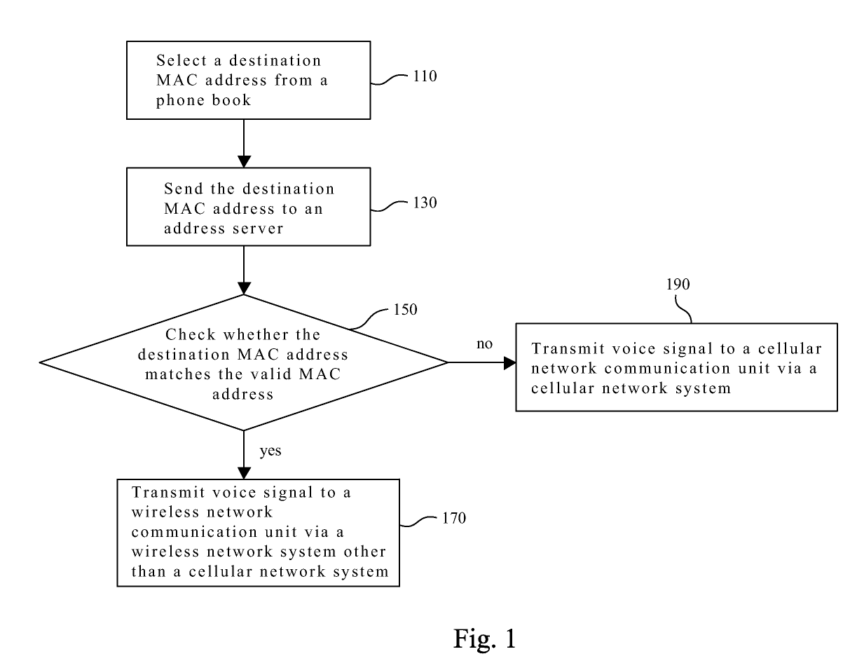

This invention discloses an Internet phone communication method and a system thereof. The Internet phone communication method or system is related to VoIP (Voice over Internet Protocol). FIG. 1 is a flow chart showing an Internet phone communication method according to one embodiment of this invention. The Internet phone communication method includes the following steps. At step 110, a destination media access control address from a phone book is selected. At step 130, the destination media access control address is transmitted to an address server having at least one valid media access control address stored therein. At step 150, whether the destination media access control address matches the valid media access control address is checked. At step 170, when the destination media access control address matches the valid media access control address, communicating with a receiver having the destination media access control address or the valid media access control address is performed via a wireless network system other than a cellular network system. The wireless network system other than the cellular network system may comprise a WLAN, Wi-Fi, or one of any other Internet access wireless networks. In addition, the wireless network system can also cover a future wireless network which can also be regarded as a cellular network system, such as a WiMAX (the Worldwide Interoperability for Microwave Access) system. Since WiMAX may provide wireless transmission of data in a variety of ways, ranging from point-to-point links to full mobile cellular-type access such as fixed WiMAX and mobile WiMAX, the method and system of this invention may be applied to WiMAX as well. At step 190, when the destination media access control address does not match the valid media access control address, communicating with the receiver via a cellular network system, such as a GSM, GPRS, or CDMA system, is performed.

For the majority of mobile phone users, this embodiment can provide the receiver a new way of communication, which is automatically adjusting communication method by checking whether the destination media access control address matches the valid media access control address. However, it is necessary to meet the following preconditions in order to use this Internet phone communication method. First, the caller has to store the receiver's media access control address on his or her mobile phone. For example, the caller can save the receiver's media access control address in one of the fields in the phone book. Second, the receiver's mobile phone has to support Wi-Fi. Once the receiver enters a hot spot, he or she is connected to a WAN, and the media access control address will be automatically uploaded to an address server set up by the service provider. The media access control address uploaded to the address server is the valid media access control address at step 150 mentioned above. The media access control address is used to determine which communication method to use in this embodiment.

Next, the steps of implementing this Internet phone communication method will be further described in detail below. A caller wants to use his or her mobile phone to call a receiver. The actual steps involved are illustrated in FIG. 1. At step 110, the caller selects the receiver's phone number from the phone book stored on his or her mobile phone. The related data fields of the receiver stored on the phone book also includes the receiver's media access control address. That is, when the caller is ready to call the receiver, the destination media access control address (the receiver's media access control address) is being selected

At Step 130, when the caller calls the receiver, the destination media access control address is sent to the server setup by the service provider. The server will determine whether the data sent from the caller includes a media access control address. If the data is determined to include a media access control address, then proceed to step 150.

An address server can be placed in the server setup by the service provider. There is at least one valid media access control address stored in the address server. At step 150, whether the destination media access control address matches the valid media access control address is checked. At step 170, when the destination media access control address matches one of the valid media access control addresses, it means that the receiver has entered one of the hot spots and connected to the WLAN. Then, the caller can communicate with the receiver having the destination media access control address or the valid media access control address via the wireless network system other than a cellular network system. This is different from communicating with the receiver via a cellular network. The voice signals are transmitted to the wireless network communication unit on the receiver's side via the wireless network system other than the cellular network system.

Step 170 may further include the following steps such as encoding the voice signals, converting the encoded voice signals into data packets, and transmitting the data packets to the wireless network communication unit. The description here is related to the process of transmitting voice signals over the IP network. By describing the process in a simple form, the mobile phone on the caller's side first converts voice signals into data streams, and sends the data streams to the destination, which is the mobile phone on the receiver's side. When receiving the data streams, the mobile phone on the receiver's side converts the data streams back to voice signals. This process can be more specifically described as follows: first, the voice signals are encoded into digits. In other embodiments, a step of compressing the voice signals may be involved. Second, the encoded voice signals are converted into data packets, including the processes such as encapsulating protocol information. Then, the data packets are transmitted to a wireless network communication unit on the receiver's side. In the course of data transferring, since the IP protocol is designed for inter-connections of various networks, during the transmitting process, re-packaging or re-addressing of packets may be involved based on the actual network conditions.

At step 190, when the destination media access control address does not match any of the valid media access control addresses, it means that the receiver is not in the hot spots and is not connected to the WLAN. Then, the caller can only communicate with the receiver via the cellular network system based on the receiver's phone number. The voice signals are transmitted to the cellular network communication unit on the receiver's side via the cellular network system.

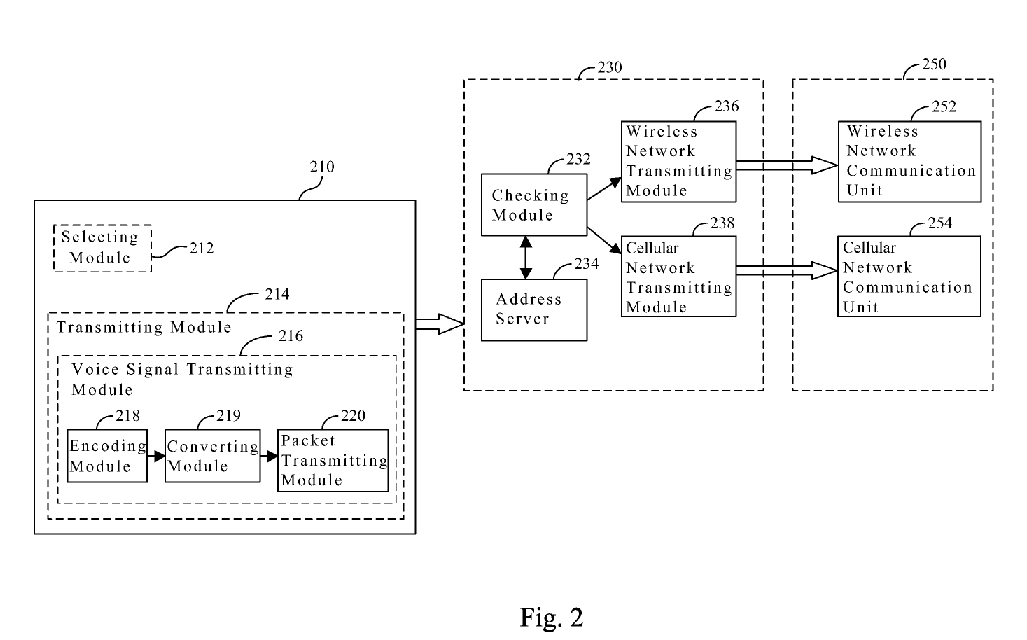

FIG. 2 is a block diagram showing an Internet phone communication system according to another embodiment of this invention. The Internet phone communication system includes a selecting module 212, a transmitting module 214, a checking module 232, an address server 234, and a wireless network transmitting module 236. This Internet phone communication system may also include cellular network transmitting module 238. The selecting module 212 and transmitting module 214 are configured at the caller's mobile phone 210.

The checking module 232, address server 234, wireless network transmitting module 236, and cellular network transmitting module 238 are configured at the server 230 setup by the receiver's WLAN service provider. The address server 234 is used to store at least one valid media access control address. The selecting module 212 is used to select a destination media access control address. The transmitting module 214 is used to transmit the destination media access control address to the address server 234. The checking module 232 is used to check whether the destination media access control address matches the valid media access control address. The wireless network transmitting module 236 is used to communicate with the receiver having the destination media access control address or the valid media access control address via the wireless network system other than a cellular network system, when the destination media access control address matches the valid media access control address.

The transmitting module 214 may include a voice signal transmitting module 216, used for transmitting voice signals to a wireless network communication unit 252 on the receiver's mobile phone. Further, the voice signal transmitting module 216 includes an encoding module 218, a converting module 219, and a packet transmitting module 220. The encoding module 218 is for encoding the voice signals. The converting module 219 is for converting the encoded voice signals into data packets. The packet transmitting module 220 is for transmitting the data packets to the wireless network communication unit 252.

In addition, the Internet phone communication system could also include a cellular network transmitting module 238 for communicating with the receiver via a cellular network system when the destination media access control address does not match the valid media access control address. In this case, the voice signals are transmitted from the voice signal transmitting module 216 of the transmitting module 214 to the cellular network communication unit 254 on the receiver's mobile phone 250 via the cellular network transmitting module 238.

With continuous reference to FIG. 2, the operations of each module or unit in this Internet phone communication system will be described below. The caller obtains the receiver's contact information via the selecting module 212 on his or her mobile phone 210. The contact information includes information such as the receiver's phone number and media access control address. Next, when the caller calls the receiver, the transmitting module 214 transmits the destination media access control address (the receiver's media access control address) to the address server 234 in the server 230 set up by the receiver's service provider. If the caller and the receiver belong to the same service provider, then the data transmission process from the server set up by the caller's service provider to the server set up by the receiver's service provider can be omitted. If the caller and the receiver belong to two different service providers, then the data will be transmitted to the server set up by the caller's service provider first and to the server set up by the receiver's service provider via network devices such as IP routers.

The checking module 232 accesses the valid media access control addresses stored in the address server 234, and checks whether the destination media access control address matches any one of the valid media access control addresses stored in the address server. When the destination media access control address matches one of the valid media access control addresses, it means that the receiver has entered one of the hot spots, connected to the WLAN, and already uploaded the media access control address to the address server 234. Then, the caller can communicate with the receiver having the destination media access control address or the valid media access control address via the wireless network transmitting module 236. The voice signals are transmitted to the wireless network communication unit 252 on the receiver's mobile phone 250. In some cases, since the voice signals are transmitted via WLAN, this type of transmission can reduce the phone bill generated by receiving calls via cellular networks. In addition, when the receiver is located outside the network supported by the mobile service provider, he or she can also save the roaming cost.

Furthermore, before the voice signal transmitting module 216 transmits voice signals to the wireless network communication unit 252 on the receiver's mobile phone 250 via the wireless network transmitting module 236, the following functional operations are involved. First, the encoding module 218 encodes the voice signals. Then, the converting module 219 converts the encoded voice signals into data packets. The packet transmitting module 220 transmits the data packets to the Internet, and the data packets will be transmitted to the wireless network communication unit 252 in the end.

Otherwise, when the destination media access control address does not match any of the valid media access control addresses, it means that the receiver is not in the hot spots and is not connected to the WLAN. Thus, the destination media access control address is not uploaded to the address server 234. Then, the caller can only communicate with the receiver via the cellular network transmitting module 238 based on the receiver's phone number. The voice signals are transmitted to the cellular network communication unit 254 on the

It will be apparent to those skilled in the art that various modifications and variations can be made to the structure of the embodiment without departing from the scope or spirit of the invention. In view of the foregoing, it is intended that the embodiment cover modifications and variations of this invention provided they fall within the scope of the following claims and their equivalents.

What is claimed is:

1. An Internet phone communication method comprising:
a. selecting a destination media access control address from a phone book;
b. transmitting the destination media access control address to an address server having at least one valid media access control address stored therein;
c. checking whether the destination media access control address matches the valid media access control address; and
d. when the destination media access control address matches the valid media access control address, communicating with a receiver having the destination media access control address or the valid media access control address via a wireless network system other than a cellular network system.

2. The method of claim 1, wherein the step d of communicating comprises transmitting voice signals to a wireless network communication unit on the receiver's side via the wireless network system.

3. The method of claim 2, wherein the step d of communicating further comprises:
encoding the voice signals;
converting the encoded voice signals into data packets; and
transmitting the data packets to the wireless network communication unit.

4. The method of claim 1, further comprising a following step:
e. when the destination media access control address does not match the valid media access control address, communicating with the receiver via a cellular network system.

5. The method of claim 4, wherein step e comprises transmitting voice signals to a cellular network communication unit on the receiver's side via a cellular network system.

6. An Internet phone communication system comprising:
an address server for storing at least one valid media access control address;
a selecting module for selecting a destination media access control address;
a transmitting module for transmitting the destination media access control address to the address server;
a checking module for checking whether the destination media access control address matches the valid media access control address; and
a wireless network transmitting module for communicating with a receiver having the destination media access control address or the valid media access control address via a wireless network system other than a cellular network system, when the destination media access control address matches the valid media access control address.

7. The system of claim 6, wherein the transmitting module comprises:
a voice signal transmitting module for transmitting voice signals to a wireless network communication unit on the receiver's side via a wireless network transmitting module.

8. The system of claim 7, wherein the voice signal transmitting module comprises:
an encoding module for encoding the voice signals;
a converting module for converting the encoded voice signals into data packets; and
a packet transmitting module for transmitting the data packets to the wireless network communication unit.

9. The system of claim 6, further comprising:
a cellular network transmitting module for communicating with the receiver via a cellular network system, when the destination media access control address does not match the valid media access control address.

10. The system of claim 9, wherein the transmitting module comprises:
a voice signal transmitting module for transmitting voice signals to a cellular network communication unit on the receiver's side via a cellular network transmitting module.
